(19) United States
(12) Patent Application Publication
(10) Pub. No.: US 2026/0182586 A1
(43) Pub. Date: Jul. 2, 2026

(54) Cupcake Cork

(71) Applicant: Mowan, LLC, Humble, TX (US)

(72) Inventor: Tracy Guesnon, Humble, TX (US)

(21) Appl. No.: 18/384,536

(22) Filed: Oct. 27, 2023

Related U.S. Application Data
(63) Continuation-in-part of application No. 29/905,899, filed on Oct. 27, 2023, now Pat. No. D1110124.

(51) Int. Cl. A21B 3/13; A21D 8/06; A21D 13/24; A21D 13/32; G06Q 30/0601; G06Q 50/12

(52) U.S. Cl. CPC A21B 3/13; A21D 8/06; A21D 13/24; A21D 13/32; G06Q 30/0621; G06Q 50/12

(57) ABSTRACT

A cupcake core creator is provided as a baking tool designed to create a cavity in baked cupcakes for fillings. Comprising a body, legs, and handle, the device is positioned in a cupcake liner before adding batter. Post baking, its removal reveals a consistent cavity, facilitating effortless filling insertion and eliminating the need for separate pans or manual cake removal.

### RELATED APPLICATIONS

Any previously filed or co-pending applications of related continuity are disclosed as part of the Application Data Sheet filed pursuant to 37 C.F.R. § 1.76. All Related Applications are incorporated by reference as if fully rewritten herein.

### BACKGROUND OF THE INVENTION

### 1. Field of the Invention

The present invention relates generally to baking accessories and, more specifically, to a device designed to create a cavity in cupcakes for filling purposes, and its method of use.

### 2. Description of the Related Art

The commercial cupcake bakery market has evolved significantly over the past two decades. Originally seen as a niche within the broader bakery industry, cupcakes have carved out a distinct space for themselves, largely owing to their versatility, convenience, and the personal touch they can offer compared to larger cakes.

Such a market has seen a notable surge in popularity, especially after television shows like “Cupcake Wars” highlighted the creativity and potential of cupcakes. This has led to a proliferation of boutique cupcake bakeries in urban areas and has sparked interest in gourmet and artisanal varieties, with an emphasis on innovative flavors, fillings, and designs. From seasonal to international inspirations, bakeries are constantly pushing the envelope to differentiate themselves.

Whether in commercial bakeries or for the “at home” baker, customization of baked goods is increasingly desired, but hard to achieve in that specialty equipment that allows for such customization, especially with cupcakes, is not readily available.

Many have attempted to combat this problem without success, but some methods and devices are known to incorporate various mechanisms for customizing baked goods. For example:

U.S. Patent Application Publication No. 2015/0237875, published in the name of Skoczen, teaches a method of baking alcohol infused cupcakes is provided. The cupcakes may be at least partially baked and then dehydrated. A user may then inject alcohol into the dehydrated cupcake. The cupcakes may be chilled and then eaten.

U.S. Patent Application Publication No. 2008/0095908, published in the name of Vendi et al., discloses a baking cup features a corrugated sidewall and a base. The interior surface of the side wall is provided with a fill line spaced from the top edge of the sidewall. When the baking cup is filled with batter to the fill line, a resulting baked cupcake or other food item will have a desired predetermined height or thickness.

U.S. Pat. No. 6,827,324, issued in the name of Yother, teaches a baked goods baking kit for making cupcakes, in particular, having hollowed centers which can be filled with filling of some sort. The baked goods baking kit includes a baking member having a main wall and also having a plurality of ornamental-shaped cup portions spacedly disposed in the main wall and being adapted to hold baking batter therein; and also includes a baking mold tool being detachably attached to the baking member for forming selected shapes in the baked goods being baked in the ornamental-shaped cup portions of the baking member.

U.S. Pat. No. 2,439,854, issued in the name of Brainard, teaches a culinary implement which is used for the simultaneous preparation of a number of cookies, cakes, biscuits, hamburgers and other articles. More particularly my invention relates to that type of culinary implement which is adapted for use by hand for preparing and baking a batch of pastry or other articles. The primary object is to provide a hand operable forming implement which is adapted to simultaneously mold a plurality of pastry or other articles of any desired shape and even thickness and having smooth marginal edges, without sticking to mold surfaces. Among further objects is to shorten the time for producing and to facilitate and simplify the means for the production of pastry or other articles for household service.

U.S. Pat. No. 3,590,728, issued in the name of Stanley, teaches a pan or mold for use in the production of baked cones capable of being used for holding other foods such as ground meat or the like and which pan or mold includes complementary conical mold members with receiving and received aligning portions with the spaces between the larger ends of the cones open to allow substantially unobstructed spaces between the larger extremities for the maximum expansion of the dough and the provision of irregular upper end walls on the cone.

U.S. Patent Application Publication No. 2012/0006699, published in the name of Hofmann, teaches a modular container for the preparation of foods, in particular baked goods, by cooking, comprising a self-supporting base plate having an extension in one plane, and limiting elements which project from the plane and which are detachably connected to the base plate.

U.S. Pat. No. 8,499,684, issued in the name of Premraj, discloses a Cupcake/Muffin Hole Maker for use with a baking pan of the type formed from a sheet having a plurality of frusto-conical depressions and inter-spaces between the depressions, a hole maker. The hole maker includes a plate having upper and lower surfaces. A plurality of tubes each has an upper end secured to the lower surface of the plate. The tubes each have a lower end positionable in an associated depression. The upper and lower ends of each tube are separated by a tube length. A plurality of similarly configured posts are provided. The posts each have an upper end secured to the lower surface of the plate. The posts each have a lower end positionable on the upper surface of the sheet at an associated inter-spacing.

And, U.S. Patent Application Publication No. 2013/0108749, published in the name of bombard et al., teaches a baking accessory used to form cavities of various sizes and shapes in the top of cupcakes, muffins or other baked goods. The baking accessory consists of two components. A cavity forming attachment and the base/stem embodiment are assembled to form the desired cavity. The interface between the stem and the receiving hole in the base of the cavity forming attachment allows for repeatable vertical adjustment of the cavity forming attachment. Such a baking accessory creates an exposed cavity on top of the baked surface that can be filled with various food products, and allows the baked mixture to rise un-constricted, producing a naturally rounded and aesthetically pleasing baked surface.

Consequently, a need has been felt for providing an apparatus for, and method of creating a cavity in cupcakes for purposes of introducing a filling.

### SUMMARY OF THE INVENTION

It is thus an object of the present invention to provide baking that allows a cavity to be formed directly within a cupcake during baking.

It is a feature of the present invention to automatically create a cavity within a cupcake, for filling, without the need to purchase an additional pan or waste cake by removing a center from a cooked confection.

Briefly described according to a preferred embodiment, a cupcake cork is provided formed of a silicone body having that has three (3) thin “legs” extending downward with a cylinder top. A tab extends from the top. The cylindrical body is sized to be placed within a cupcake liner, which may be filled ⅓ to ½ with batter prior to placement of the body into the liners. With the legs placed first in each cupcake with the cylinder piece about halfway in, additional batter may be introduced. When the cupcake bakes it will automatically create a hollow core for filling. The top of the cylindrical body has “pull tab” to allow grasping for easy removal after baking.

An advantage of the present invention is that is has a form factor capable of being scaled for different sized cupcakes.

Another advantage of the present invention is that any size variation may be used in conjunction with existing, otherwise conventional cupcake baking sheet or pan.

Yet another advantage may include a decreased bake time, as compared with otherwise conventional cupcakes of similar overall size that results from the displacement of the batter and, subsequently, less batter by mass than a cupcake formed without a center cavity.

Further, use of the present invention allows for a reduction in wasted batter, and an allows for “filling on demand” to prevent the cake portion from becoming soggy as could occur if pre-filled with a filling with a higher moisture content.

Further objects, features, elements and advantages of the invention will become apparent in the course of the following description.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a front isometric view of a cupcake cork 100, according to an embodiment of the present invention;

FIG. 2 is a rear isometric view of a cupcake cork 100, according to an embodiment of the present invention;

FIG. 3 is a left side view of a cupcake cork 100, according to an embodiment of the present invention;

FIG. 4 is a right-side view of a cupcake cork 100, according to an embodiment of the present invention;

FIG. 5 is a front view of a cupcake cork 100, according to an embodiment of the present invention;

FIG. 6 is a top view of a cupcake cork 100, according to an embodiment of the present invention;

FIG. 7 is a bottom view of a cupcake cork 100, according to an embodiment of the present invention;

FIG. 8a is an in-use view of a cupcake cork 100, according to an embodiment of the present invention, illustrating batter 900 poured into a liner 930 with the body 200 visible above the batter 900;

FIG. 8b is an in-use view of a cupcake cork 100, according to an embodiment of the present invention, illustrating the cupcake 910 after baking; and,

FIG. 8c is an in-use view of a cupcake cork 100, according to an embodiment of the present invention, illustrating the cavity 280 left in the cupcake 910 once the invention is removed.

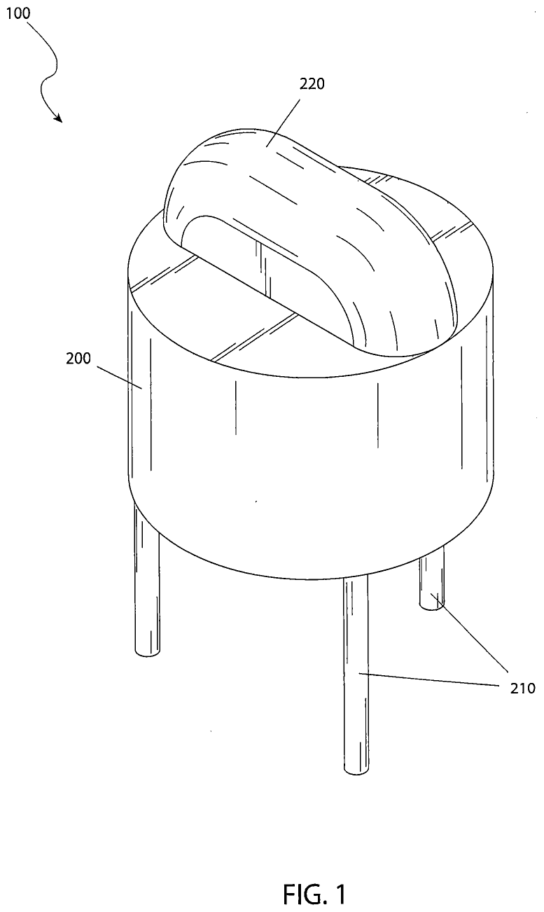

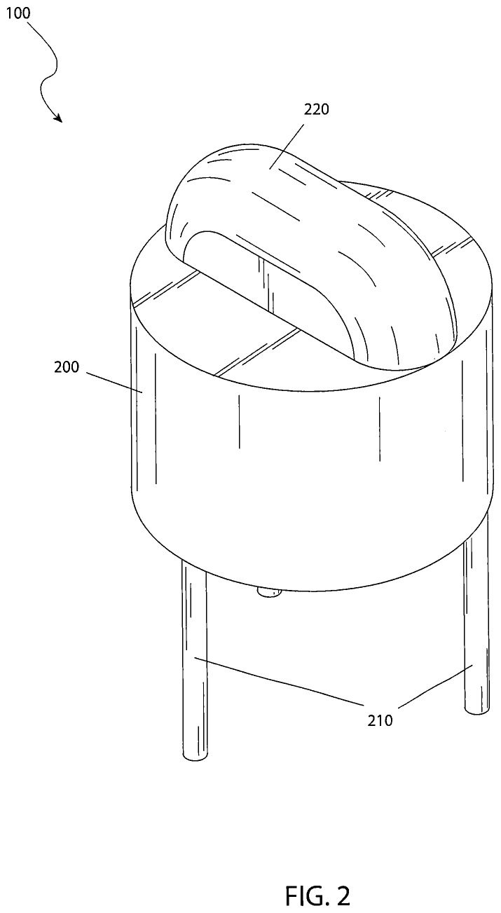

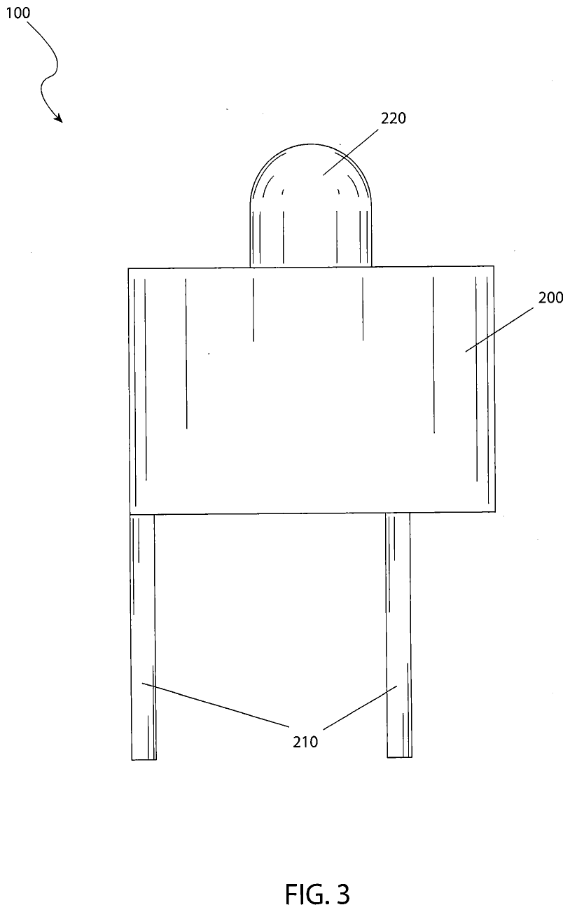

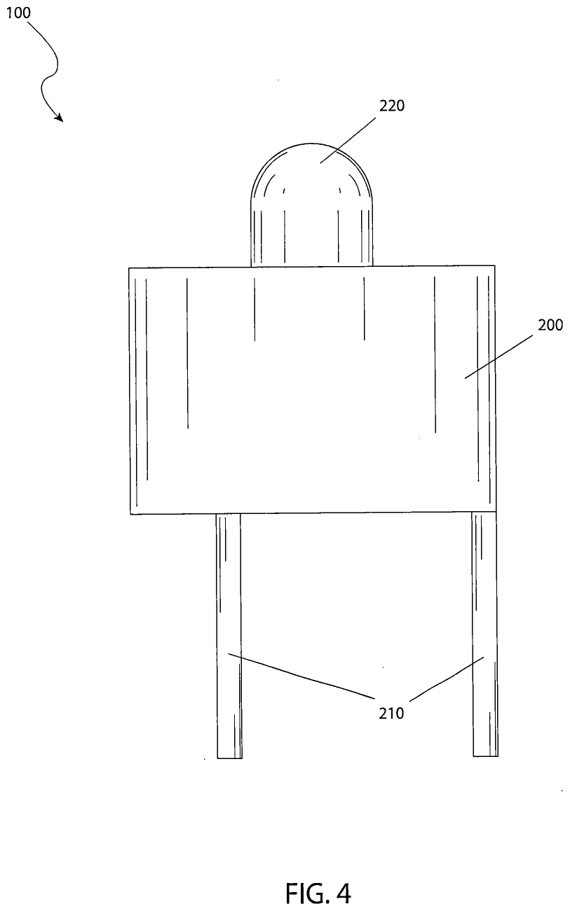

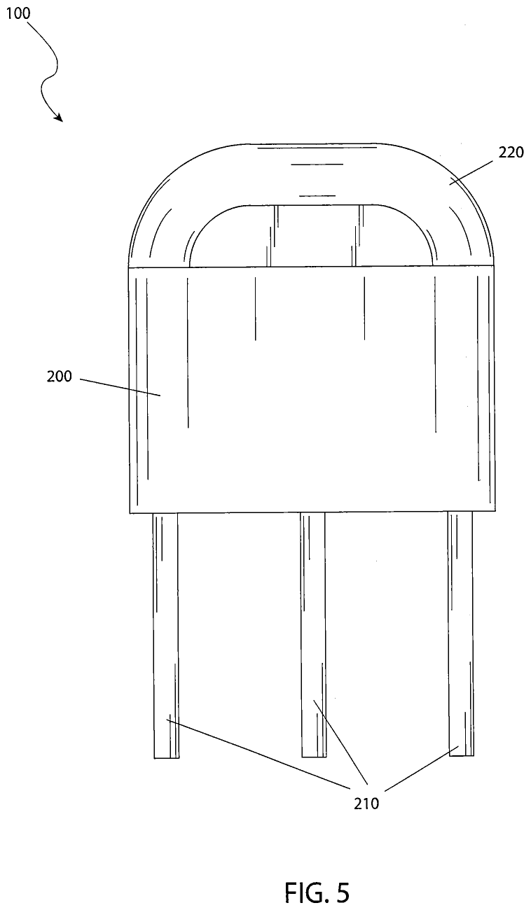

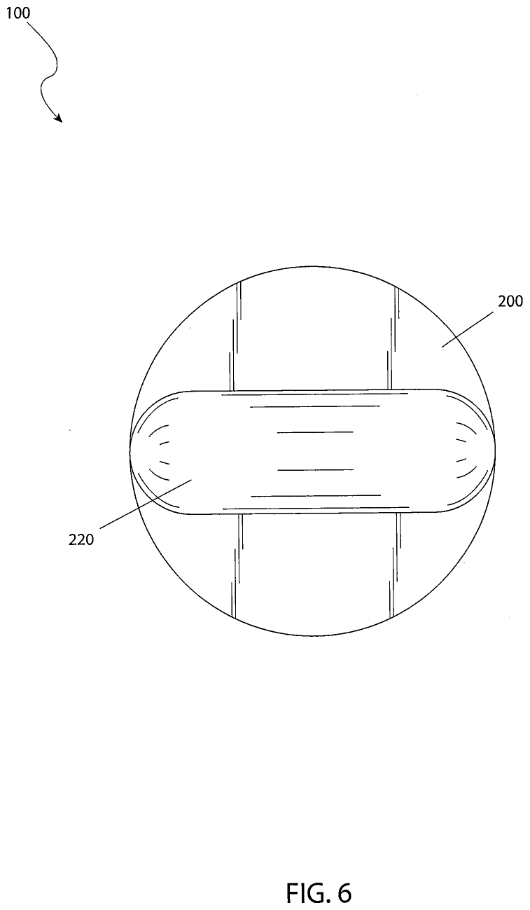

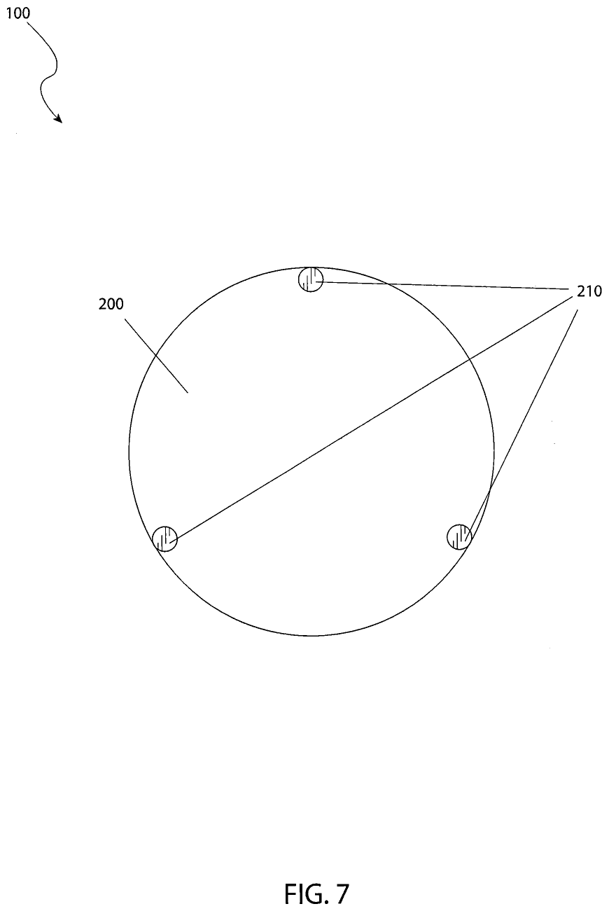

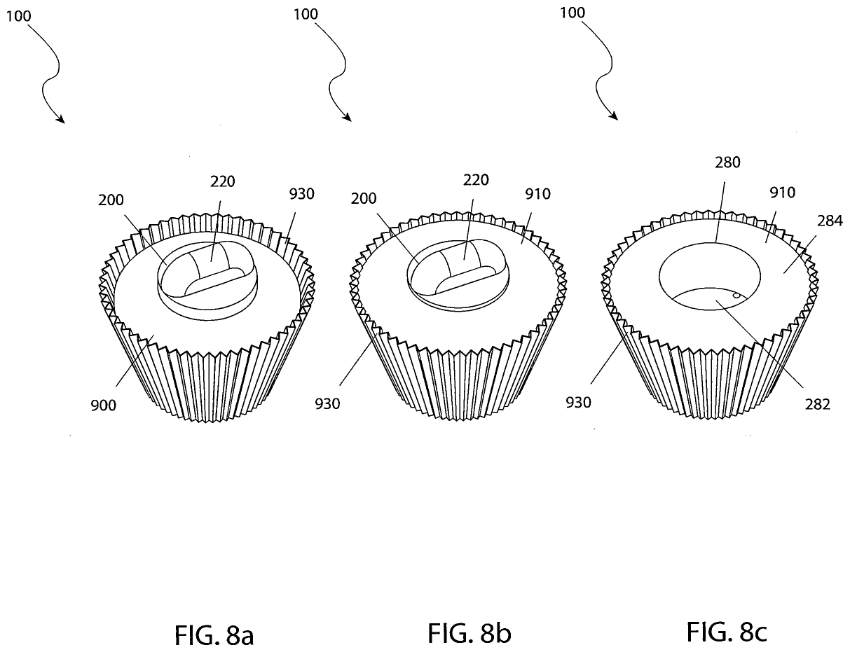

DESCRIPTIVE KEY

| | |
|---|---|
| 100 | cupcake cork |
| 200 | body |
| 210 | leg |
| 220 | handle |
| 280 | cavity |
| 282 | bottom layer of cupcake |
| 284 | surrounding wall of cupcake |
| 900 | batter |
| 910 | cupcake |
| 930 | cupcake liner |

### DESCRIPTION OF THE PREFERRED EMBODIMENTS

The best mode for carrying out the invention is presented in terms of its preferred embodiment, herein depicted within the Figures.

### 1. DETAILED DESCRIPTION OF THE FIGURES

Before explaining the present invention in detail, it is important to understand that the invention is not limited in its application to the details of the construction illustrated and the steps described herein. The invention is capable of other embodiments and of being practiced or carried out in a variety of ways. It is to be understood that the phraseology and terminology employed herein is for the purpose of description and not of limitation.

Referring now to the drawings, wherein like reference numerals indicate the same parts throughout the several views, the present invention is directed to a cupcake cork (herein described as the “invention”) 100. The invention 100 may comprise a body 200, a plurality of legs 210, and a handle 220. The invention 100 may be a baking accessory that may be operable to form a cavity 280 in the top of a cupcake 910 such that the cupcake 910 may be filled with filling. The invention 100 may be placed into a cupcake liner 930 prior to pouring batter 900 into the cupcake liner 930 and may prevent the batter 900 from flowing into the top center of the cupcake liner 930. The invention 100 may be removed from the cupcake liner 930 after baking the cupcake 910 to exposed the cavity 280. A plurality of the inventions 100 may be used, one (1) per pocket for every pocket in a cupcake pan. The invention 100 may be reusable.

The body 200 may be a cylindrical plug. In some embodiments, the body 200, as seen from beneath, may be hollow. The body 200 may be denser than the batter 900 such that the body 200 is prevented from floating in the batter 900. The body 200 may be supported above the bottom of the cupcake liner 930 by the legs 210.

The legs 210 may be coupled to the bottom of the body 200 and may project downward from the body 200. The legs 210 may be of equal length.

In a preferred embodiment, there may be three (3) legs.

The handle 220 may be coupled to the top of the body 200. The handle 220 may be adapted for a user to grasp while moving the invention 100. In some embodiments, the handle 220 may be a tab projecting vertically upwards from the top of the body 200 and centered on the body 200.

The body 200 and the legs 210 may be heat-resistant and therefore oven safe. In some embodiments, the body 200, the legs 210, or both may comprise a non-stick coating.

As non-limiting examples, the body 200, the legs 210, or all may be made of a metal such as stainless steel, copper, cast iron, aluminum, or anodized aluminum, ceramic materials such as porcelain or terra cotta, silicone, glass, or any combination thereof. Preferably the materials shall be heat-resistant and relatively inexpensive and easy to manufacture.

The batter 900 may be poured into the cupcake liner 930 that are placed on a cupcake pan. The batter 900 may initially fill the cupcake liner 930 from one (1) side to the other side except where the legs 210 are located. Upon reaching the bottom of the body 200, the batter 900 may fill only the portion of the cupcake liner 930 that surrounds the body 200, thus leaving the cavity 280 void of the batter 900. The cupcake liner 930 may be partially filled to allow room for expansion of the batter 900 during the baking process. The cupcake liner 930 may typically be filled between one-third (⅓) to one-half (½) full of batter 900 of the capacity thereof. The invention 100 may then be inserted into the center of the batter 900 such that the legs 210 contact the bottom of the cupcake liner 930. During baking, the batter 900 may expand and may rise to the top of the cupcake liner 930. After baking, the cupcakes 910 and the cupcake liners 930 may be removed from the cupcake pan and placed on a cooling rack and the invention 100 may be removed from the cupcakes 910.

Removing the cork 100 may reveal a bottom layer of cupcake 282 created below the level of the body 200 and a surrounding wall of cupcake 284 around the cavity 280 where the body 200 was located. The cavity 280 may be filled with the filling. Icing may be placed on top of the cupcake 910 and the filling if desired.

The invention 100 may be made available in multiple sizes for use in making various size cupcakes. In a preferred embodiment, there may be three (3) sizes: a mini size, a standard size, and a jumbo size. The mini size, the standard size, and the jumbo size may be defined by a body diameter, a body height, a leg diameter, a leg height, a handle height, and a total height.

For the mini size, the body diameter may be one-point-three centimeters with an error of one-tenth of a centimeter (1.3 cm+/−0.1 cm), the body height may be two and one-half centimeters with an error of one-tenth of a centimeter (2.5 cm+/−0.1 cm), and the leg height may be zero-point-six centimeters with an error of one-tenth of a centimeter (0.6 cm+/−0.1 cm). The handle height may be one and one-quarter centimeters with an error of one-tenth of a centimeter (1.25 cm+/−0.1 cm) and the total height may be four-point-four centimeters with an error of one-tenth of a centimeter (4.4 cm+/−0.1 cm).

For the standard size, the body diameter may be one-point-nine centimeters with an error of one-tenth of a centimeter (1.9 cm+/−0.1 cm), the body height may be three-point-two centimeters with an error of one-tenth of a centimeter (3.2 cm+/−0.1 cm), and the leg height may be zero-point-eight centimeters with an error of one-tenth of a centimeter (0.8 cm+/−0.1 cm). The handle height may be one and one-quarter centimeters with an error of one-tenth of a centimeter (1.25 cm+/−0.1 cm) and the total height may be five-point-three centimeters with an error of one-tenth of a centimeter (5.3 cm+/−0.1 cm).

For the jumbo size, the body diameter may be three-point-two centimeters with an error of one-tenth of a centimeter (3.2 cm+/−0.1 cm), the body height may be four-point-four centimeters with an error of one-tenth of a centimeter (4.4 cm+/−0.1 cm), and the leg height may be one-point-three centimeters with an error of one-tenth of a centimeter (1.3 cm+/−0.1 cm). The handle height may be one and one-quarter centimeters with an error of one-tenth of a centimeter (1.25 cm+/−0.1 cm) and the total height may be seven centimeters with an error of one-tenth of a centimeter (7.0 cm+/−0.1 cm).

### 2. OPERATION OF THE PREFERRED EMBODIMENT

In use, the pockets of a cupcake pan may be lined with cupcake liners 930 in preparation for making cupcakes 910. One (1) of the inventions 100 may be placed into each of the cupcake liners 930. Batter 900 may be poured into the cupcake liners 930 to fill the cupcake liners 930 between one-third (⅓) to one-half (½) of their capacity full of batter 900. The cupcake pan may be placed into a hot oven to bake. As the cupcakes 910 bake, the batter 900 may rise to the top of the cupcake liners 930. The cupcake pan may be removed from the oven. The cupcakes 910 and the cupcake liners 930 may be removed from the cupcake pan and may be placed on a cooling rack. The invention 100 may be removed from each of the cupcakes 910 to reveal the cavities 280 where the filling may be placed.

In all settings, but especially in a commercial setting, use of the present invention may allow a user to create a hollow cake structure directly in the baking of the cupcake, with concentrically encapsulated cavity directly within the cupcake. This may allow a user to pre-bake the cupcake cake portion and allow it to be filled and topped later. Such a capacity, in a commercial setting especially, can allow for a customer to order a customized cupcake, selecting a favorite cake flavor, filling, frosting and/or topping in a way that can be created upon ordering. By providing such customization capacity, a very high number of combinations can be customized, all from an inventory of various ingredients and in a way that can eliminate waste or creating an unwanted/undesired combination.

The foregoing descriptions of specific embodiments of the present invention are presented for purposes of illustration and description. The Title, Background, Summary, Brief Description of the Drawings and Abstract of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the Detailed Description, with each claim standing on its own as a separately claimed subject matter.

The claims are not intended to be limited to the aspects described herein but are to be accorded the full scope consistent with the language claims and to encompass all legal equivalents. Notwithstanding, none of the claims are intended to embrace subject matter that fails to satisfy the requirement of 35 U.S.C. § 101, 102, or 103, nor should they be interpreted in such a way. Any unintended embracement of such subject matter is hereby disclaimed. They are not intended to be exhaustive nor to limit the invention to precise forms disclosed and, obviously, many modifications and variations are possible in light of the above teaching. The embodiments are chosen and described in order to best explain principles of the invention and its practical application, to thereby enable others skilled in the art to best utilize the invention and its various embodiments with various modifications as are suited to the particular use contemplated. It is intended that a scope of the invention be defined broadly by the Drawings and Specification appended hereto and to their equivalents. Therefore, the scope of the invention is in no way to be limited only by any adverse inference under the rulings of Warner-Jenkinson Company, v. Hilton Davis Chemical, 520 US 17 (1997) or Festo Corp. v. Shoketsu Kinzoku Kogyo Kabushiki Co., 535 U.S. 722 (2002), or other similar caselaw or subsequent precedent should not be made if any future claims are added or amended subsequent to this patent application.

1. A cupcake core creator comprising:
a generally cylindrical body adapted to be operable to form a displacement cavity in a top of a cupcake;
said cylindrical body being heat resistant or oven safe and being denser than cake batter such that the cylindrical body is prevented from floating in the batter or otherwise moving upward during a baking cycle;
a plurality of legs extending downward from the cylindrical body at an equal length and adapted to support the cylindrical body above a bottom of a cupcake liner;
a handle comprising a tab projecting vertically upward from and centered on a top of the cylindrical body, said handle adapted to be directly manually graspable without requiring a separate removal tool;
wherein when placed within a cupcake liner containing a quantity of cake batter prior to cooking, a cupcake is thereby formed having a cake sidewall circumscribing a hollow, fillable cavity.

2. (canceled)

3. The cupcake core creator of claim 1, further comprising three said legs projecting downward from the body at an equal length.

4. (canceled)

5. The cupcake core creator of claim 1, further comprising a nonstick coating covering said body and said legs.

6. The cupcake core creator of claim 1, wherein said cylindrical body is formed of a material selected from a group consisting of: stainless steel; copper; cast iron; aluminum;
anodized aluminum; ceramic; porcelain; terra cotta; silicone; glass; or any combination thereof.

7. The cupcake core creator of claim 1, wherein said cylindrical body has a body diameter between about 1.3 cm to about 3.2 cm.

8. The cupcake core creator of claim 7, wherein said cylindrical body has a body height between about 2.5 cm to about 4.4 cm.

9. A method for creating a cavity in a baked cupcake using the cupcake core creator of claim 1, comprising the steps of:
placing or pouring batter into a cupcake liner positioned within a cupcake pan;
positioning the cylindrical body in the cupcake liner with the legs directed downward and the handle projecting upward;
pouring batter into the cupcake liner and about at least a portion of the cylindrical body and leaving the top center region void due to obstruction by the body;
baking the cupcake, the resultant cupcake comprising a bottom layer below the level of the cylindrical body and a peripheral wall encircling a cavity; and
removing the cupcake core creator, post baking, by directly grasping the handle without requiring a removal tool, to reveal the cavity adapted to be filled with confections or other foodstuffs.

10. The method of claim 9, further including the step of filling the cavity with a desired filling post removal of the cylindrical body.

11. The method of 9, wherein multiple cupcake core creators are utilized in a cupcake pan, with one cylindrical body per pocket of the pan.

12. The method of claim 11, wherein the batter-filled liners are filled between one-third ( ) to one-half (½) of their capacity to accommodate batter expansion during baking.

13. A point-of-purchase cupcake customization system comprising:
a physical display module presenting a variety of cupcakes having fillable cavities of a select number of cake flavors available for selection, wherein each cupcake is formed of the method of claim 9 using a cupcake core creator;
a subsequent physical display showcasing a range of fillable cavity contents or fillings for user choice, said fillings adapted to be inserted into the fillable cavities of the cupcakes;
an additional physical module offering frosting type choices to be applied on the cupcake's top; and
an ending selection point comprising a physical display with a variety of topping types available for user preference;
wherein the user can physically select from each module to build a personalized cupcake from base to top, the personalized cupcake comprising a cupcake body having a peripheral wall encircling the fillable cavity, the user-selected filling within the fillable cavity, the user-select frosting on top, and the user-selected topping.

14. The system of claim 13, wherein said display module for cake flavors offers choices from a group consisting of: vanilla, chocolate, red velvet, carrot, lemon, and any combination thereof.

15. The system of claim 13, wherein said subsequent display for cavity contents or fillings comprises selections from a group consisting of: chocolate ganache, fruit jams, cream fillings, caramel, and any combination thereof.

16. The system of claim 13, wherein said additional module for frosting type offers choices from a group consisting of: cream cheese, buttercream, whipped cream, chocolate frosting, and any combination thereof.

17. The system of claim 13, wherein said ending selection point for topping types showcases options from a group consisting of: sprinkles, fruit pieces, chocolate shavings, nuts, and any combination thereof.

18. A method for offering point-of-purchase customized cupcakes using the system of claim 13, comprising the steps of:
providing a plurality of cupcakes, each cupcake having a fillable cavity formed a cupcake core creator presenting available cake flavor options to the user via the physical display module;
receiving user's cake flavor choice;
showcasing fillable cavity contents or fillings for user selection via the subsequent physical display;
receiving user's filling choice;
filling the fillable cavity of the selected cupcake with the user-selected filling;
offering frosting types to the user;
receiving user's frosting choice;
displaying topping type choices to the user; and
wherein following the selection process, the customized cupcake is then prepared based on the user's selections, including filling the fillable cavity with the user-selected filling and applying the user-selected frosting and topping.

19. The method of claim 18, further including the step of filling the cavity with the user-selected filling post removal of the cylindrical body.

20. The method of claim 19, wherein post filling, the user-selected frosting is applied on the top of the cupcake.
